(19) United States
(12) Patent Application Publication
(10) Pub. No.: US 2026/0339093 A1
(43) Pub. Date: Oct. 29, 2026

(54) Microscopy System and Method for Improving a Quality of Microscope Images through a Brightness Value Transformation

(71) Applicant: Carl Zeiss Microscopy GmbH, Jena (DE)

(72) Inventors: Manuel Amthor, Jena (DE); Daniel Haase, Zoellnitz (DE); Ralf Wolleschensky, Jena (DE)

(21) Appl. No.: 19/646,752

(22) Filed: Apr. 14, 2026

(30) Foreign Application Priority Data
Apr. 23, 2025 (DE) 10 2025 115 689.1

(51) Int. Cl. G02B 21/36

(52) U.S. Cl. CPC G02B 21/367; G02B 21/368

(57) ABSTRACT

For improving an image quality of a microscope image, a brightness value transformation is applied to the microscope image. The parameter values of the brightness value transformation are defined depending on contextual information relating to the microscope image that specify at least imaging properties and/or depicted structures, and/or so that differences between the microscope image and a reference image are reduced, wherein the reference image is determined based on the microscope image or associated contextual information.

### REFERENCE TO RELATED APPLICATIONS

The current application claims the benefit of German Patent Application No. 10 2025 115 689.1, filed on 23 Apr. 2025, which is hereby incorporated by reference.

### FIELD OF THE DISCLOSURE

The present disclosure relates to a microscopy system and a computer-implemented method for improving an image quality of microscope images.

### BACKGROUND OF THE DISCLOSURE

Captured microscope images are generally displayed to a user on a screen in the form of live images immediately following capture or during ongoing observation. With standard microscope control and display software, a user can change display parameters to render structures in the microscope image more visible. For example, a contrast, a brightness or a gamma value for the image display can be modified to improve the visibility of captured structures. Depending on the display software, display parameters can be adjusted via a display curve, which illustrates a mapping of the brightness values of the microscope image to new brightness values graphically. It is thereby possible to set, for example, a gamma value, or in particular a minimum brightness value that is to be displayed as black and a maximum brightness value that is to be displayed as white.

A manual adjustment of the display parameters, however, is time-consuming and prone to errors. Depending on the user's experience, only moderate results are achieved, which generally also cannot be replicated with precision. This makes it particularly difficult to compare a plurality of images. Automatic adjustments based on simple criteria or heuristics also often fail to deliver satisfactory results and require subsequent corrections, which again call for expertise. For instance, an automatic dynamic range stretching/spreading of grey levels/tonal values is possible, by means of which the darkest pixel value in the original image is shifted to the black point and the lightest pixel value in the original image is shifted to the white point. This makes it possible to use the entire available brightness range from a minimum value (e.g. zero) to a maximum value (e.g. 255) although the brightness values in the original image cover only a subset of the possible values (e.g. values from 10 to 220). A certain contrast enhancement can thereby be achieved, although the result is generally far from ideal. Ideal display parameters vary as a function of, among other things, the overall frequency distribution of pixel values, the imaging technique (for instance, phase-contrast images and fluorescence images should be processed differently), the depicted samples, image noise and undesirable structures. For example, in the event of crosstalk in a fluorescence image, the corresponding undesirable structures should be rendered less visible rather than more visible. This is not possible using simple automatic contrast enhancements or similar approaches.

A simple normalization method, e.g. a min-max normalization or percentile normalization, thus does not yield a satisfactory result and requires a subsequent manual readjustment. The optimal setting of the display curve is highly dependent on the application. In the event of hammerscale artefacts, for instance, more of the lower range of the brightness value distribution must be clipped to remove the artefacts.

As background, reference is made to the following articles, which describe a contrast enhancement of microscope images through histogram equalization:
Sri Hartati et al., “The Digital Microscope and Its Image Processing Utility”, TELKOMNIKA, Vol. 9, No. 3, December 2011, pp. 565-574, ISSN: 1693-693
Marina E. Plissiti et al., “Overlapping Cell Nuclei Segmentation Using a Spatially Adaptive Active Physical Model”, IEEE TRANSACTIONS ON IMAGE PROCESSING, VOL. 21, NO. 11, NOVEMBER 2012

In a histogram equalization, the frequency of different pixel values is distributed more evenly to improve contrast. It is also possible to use an adaptive histogram equalization or contrast-limited adaptive histogram equalization (CLAHE) to improve image quality, as described in:
https://en.wikipedia.org/wiki/Adaptive_histogram_equalization

In this process, an image is divided into sections (tiles), a histogram equalization is performed for each section, and a bilinear interpolation is carried out at the boundaries between the sections. To prevent an excessive amplification of image noise in low-contrast sections, contrast limiting is applied. The adjustment of brightness values of the image in a histogram equalization thus occurs solely as a function of statistical information of the image in question. No application-specific image optimization is achieved.

Machine-learned image-to-image models are also known that improve image quality, e.g. through a contrast enhancement, a noise reduction or a removal of artefacts. However, with machine-learned image-to-image models, there is always a risk of hallucinations, i.e. the addition of structures not contained in the original image. Current image-to-image models thus do not necessarily achieve the goal of improving image quality, as there is the risk that they may falsify the original image. This risk can be reduced through the addition of control mechanisms, but this leads to increased complexity while a residual risk nevertheless remains. Moreover, image-to-image models that have to process the full resolution of the microscope image are computationally relatively intensive. A subsequent manual adjustment is generally not possible or only possible to a very limited extent when machine-learned image-to-image models are used. In addition to a potential introduction of artefacts, undesirable consequences of image-to-image models can also include other falsifications of the raw data, e.g. when image noise is significantly altered or removed, or when image structures are altered.

To provide a better understanding of the technical background of the invention, reference is made in the following to different machine learning techniques.

For processing text data, in particular transformer-based language models (large language models, LLMs) such as GPT and BERT are used, as described, for example, in:
Brown, T., et al., “Language Models are Few-Shot Learners”, arXiv: 2005.14165v4 [cs. CL] 22 Jul. 2020
Devlin, J., et al., “BERT: Pre-training of Deep Bidirectional Transformers for Language Understanding”, arXiv:1810.04805v2 [cs.CL] 24 May 2019

The transformer technology described in these articles can also be applied to image processing. A model known as VisionTransformer ViT with a transformer for image processing is described in:
Dosovitskiy, A., et al., “AN IMAGE IS WORTH 16×16 WORDS: TRANSFORMERS FOR IMAGE RECOGNITION AT SCALE”, arXiv: 2010.11929v2 [cs.CV] 3 Jun. 2021

Alternatively to ViTs, convolutional neural networks (CNNs) are also widely used for image processing.

A multimodal model learns a mapping from text and associated image data into a shared multimodal feature space, for which the output of an image encoder (e.g. ResNet or ViT) and the output of a text encoder are respectively projected into the shared feature space, as described in:
Radford, Al., et al., “Learning Transferable Visual Models From Natural Language Supervision”, arXiv: 2103.00020v1 [cs.CV] 26 Feb. 2021

Models can also be trained using reinforcement learning, as described, for example, in:
DeepSeek-AI: “DeepSeek-R1: Incentivizing Reasoning Capability in LLMs via Reinforcement Learning”, arXiv: 2501.12948v1 [cs.CL] 22 Jan. 2025

### SUMMARY OF THE DISCLOSURE

It can be considered an object of the invention to provide a microscopy system and a method that can improve a display of a microscope image without hallucinations or other falsifications of depicted image content.

This object is achieved by the microscopy system and the methods with the features of the independent claims.

A computer-implemented method according to the invention for improving an image quality of microscope images includes: obtaining at least one microscope image; determining or establishing contextual information relating to the microscope image, wherein the contextual information relates to at least imaging properties and/or depicted structures; determining a brightness value transformation as a function of at least the contextual information; and applying the brightness value transformation to the microscope image.

In a further computer-implemented method according to the invention for improving an image quality of microscope images, at least one microscope image is obtained. At least one reference image is established for the microscope image, for which purpose in particular the microscope image and/or contextual information relating to the microscope image can be used. A brightness value transformation of the microscope image is determined by means of which a difference between the microscope image and the reference image is reduced. The brightness value transformation is applied to the microscope image. As explained in more detail in the following, the difference between the microscope image and the reference image can be captured pixelwise, can relate to an image style, or can be measured based on properties of the brightness-value frequency distributions of the images, inter alia.

A microscopy system of an embodiment according to the invention includes a microscope for image capture and a computing device that is configured to execute a computer-implemented method according to the invention.

The invention also relates to a non-volatile computer-readable data storage medium that includes a computer program with commands which, when executed by a computer, cause the computer to execute at least one computer-implemented method according to the invention.

The invention makes it possible to determine and utilize a brightness value transformation that is suitable for the microscope image in question. The brightness value transformation improves an image or display quality without the risk of hallucinations or other artefacts that occur with typical image-to-image models for improving display quality. The brightness value transformation is based not only on statistical information, but also on semantic information relating to the depicted content or imaging properties. The improvement in display quality can in particular involve a contrast enhancement for structures to be analyzed and/or a contrast reduction for undesirable artefacts.

### Optional Embodiments

Variants of the microscopy system according to the invention and of the methods according to the invention are the object of the dependent claims and are explained in the following description.

Different embodiments differ with respect to the basis of the determination of the brightness value transformation. In particular, the brightness-value transformation can be defined depending on the microscope image, of associated contextual information and/or of brightness-value properties of the microscope image, as explained in more detail in the following. Using this data, it is possible to determine/establish at least one reference image or other reference data that is used to define parameter values for the brightness value transformation.

### Brightness-Value Target Data

For the brightness value transformation, brightness-value target data can be established, e.g. a brightness-value histogram, that is typical of high-quality images of the imaging modality of the microscope image. Depending on the imaging mode of microscope images, e.g. phase contrast or fluorescence, different brightness-value histograms are characteristic of high-quality images. A brightness-value histogram is thus determined, e.g. retrieved from a database, for the imaging modality of the microscope image. The brightness value transformation can then be carried out so that the brightness-value histogram of the microscope image approaches/is brought closer to the brightness-value histogram loaded from the database.

More generally, the determination of the brightness value transformation can include establishing brightness-value target data as a function of the contextual information. The brightness value transformation is subsequently defined or determined so that the brightness-value data of the microscope image is brought closer to/approximates the brightness-value target data. “Brought closer” is understood to mean that a difference between the brightness-value data of the microscope image and the brightness-value target data is reduced by the brightness value transformation.

In principle, brightness-value data and brightness-value target data can be any parameters that describe a frequency distribution of brightness values in the image in question. This data can be the frequency distribution of pixel values (also called the histogram of brightness values) or, e.g., a homogeneity, entropy or spread of this frequency distribution and/or a minimum value and a maximum value of the frequency distribution of the pixel values.

For example, the brightness-value target data can specify a target histogram (target frequency distribution) of brightness values. The determination of the brightness value transformation can be carried out so that a brightness-value histogram of the microscope image is brought closer to the target histogram.

A histogram is understood here as the frequency distribution of pixel values of an image, i.e. the representation of how often each possible pixel value occurs in the image. The frequency distribution does not necessarily have to be represented graphically, so that it is also possible to use, instead of a graphically represented histogram, only the numerical values of the frequency distribution. For an image that includes X pixels, wherein each pixel can have a value between 0 and Y, the frequency distribution specifies for each of the values 0 to Y how often that value appears in the image. The sum of the frequencies with which the values 0 to Y occur is X.

The brightness-value target data can also specify target histogram properties (properties of a target frequency distribution), in particular a homogeneity, entropy or spread of a target frequency distribution of brightness values, i.e., a spread of a target pixel value distribution. The determination of the brightness value transformation occurs so that histogram properties of brightness values of the microscope image are brought closer to the target histogram properties. For instance, the spread of a frequency distribution of pixel values of a high-quality image that is comparable to the microscope image is established or loaded. The brightness value transformation is subsequently defined so that the spread of the frequency distribution of pixel values in the microscope image becomes more like the established/loaded spread.

Alternatively or additionally, the brightness-value target data can also specify an image statistical target for brightness values, in particular a mean, a standard deviation, a contrast and/or a saturation of pixel values. The brightness value transformation is determined so that an image statistic of the microscope image is brought closer to the image statistical target.

Brightness-value target data can be stored, e.g., in a database for different contextual information. Based on the contextual information relating to the current microscope image, a database query is carried out to retrieve appropriate brightness-value target data for that image. For example, respective image statistics (mean, standard deviation, etc.) for different imaging modes (phase contrast, fluorescence, etc.) can be stored in the database. If it is detected from image analysis or metadata that the microscope image is a phase-contrast image, the brightness-value target data stored in the database for this imaging mode is retrieved.

It is also possible to use a machine learning model to infer brightness-value target data from contextual information and/or from the microscope image. Alternatively, the machine learning model can infer the brightness value transformation directly. The machine learning model can be designed, e.g., as a classification model or a regression model. A machine-learned model can be particularly useful when a large amount of contextual information is taken into account, whereas a database does not necessarily contain corresponding data for every possible combination of different values of contextual information. A machine-learned model is also suitable when the microscope image is itself also taken into account, which will be described in more detail later on.

### REFERENCE IMAGE

In different variant embodiments, at least one reference image is determined for the microscope image. The reference image can be established in particular based on the microscope image and/or on contextual information relating to the microscope image.

To determine the brightness value transformation, either the microscope image and the reference image can themselves be compared, or properties derived from these images, in particular the respective frequency distributions of brightness values or certain properties/parameters of the frequency distributions.

In some embodiments, the brightness value transformation brings properties of the brightness-value frequency distribution of the microscope image closer to properties of the brightness-value frequency distribution of the reference image. The properties of the brightness-value frequency distribution are also referred to as brightness-value properties or brightness-value data in the present application.

In the aforementioned variants of the invention in which the determination of brightness-value target data occurs depending on contextual information, this process can include: determining at least one reference image as a function of at least the contextual information and determining brightness-value target data based on the at least one reference image. Properties of the brightness-value frequency distribution of the reference image can be used as brightness-value target data here.

Independently of whether or not the determination of brightness-value target data is based on contextual information, it can be provided that brightness-value data relating to the at least one reference image is used as brightness-value target data and that the brightness value transformation is determined so that brightness-value data of the microscope image is brought closer to the brightness-value target data.

In different embodiments, determining at least one reference image for the microscope image includes calculating the reference image from the microscope image by a learned model. The reference image can in particular be calculated from the microscope image using an image-to-image mapping or from contextual information relating to the microscope image using a text-to-image model, or it can be established through selection from an image database.

In the case of an image-to-image model, this can be trained to calculate a quality-enhanced output image (which is used as the reference image) from an input microscope image. The model can be trained in particular to render structures of interest more visible and to suppress background structures and/or to produce a contrast enhancement. In the training, it is possible to use, e.g., training target images in which a visibility of structures of interest is improved compared to input images or a visibility of interfering structures is suppressed compared to input images. The model can have been trained, e.g., as a generator in a GAN (generative adversarial network) architecture and/or include a UNet, a diffusion model, a CNN (convolutional neural network) and/or a ViT (vision transformer). The reference image calculated by the image-to-image model can be registered with respect to the microscope image, so that an object in the microscope image has the same image coordinates as in the reference image.

The image-to-image model can also include a plurality of successive models, which are trained together or separately. For example, the image-to-image model can include a transformer encoder, which calculates a compressed representation (feature vector) from the microscope image. A separately learned decoder generates the output image from the feature vector.

In principle, it is also possible to use classic algorithms for an image-to-image transformation, e.g. the CLAHE algorithm (contrast-limited adaptive histogram equalization), instead of a trained model. The resulting image has an improved display quality, e.g. a good contrast of structures of interest without certain background structures being too prominent, although in particular with deep neural networks there is no guarantee that new structures have not been hallucinated into the image. The calculated image can nevertheless serve as a reference image whose brightness-value distribution properties are to be emulated. By modifying the microscope image accordingly, it is possible for the advantageously high image quality of the reference image to be at least partially achieved, while there is no risk of a falsification of the depicted content, since the brightness value transformation cannot add new structures to the microscope image.

The reference image can be registered with respect to the microscope image. This means that the same structure or same object is located at the same image coordinates in both images or, more generally, that the relationship between the image coordinates in both images is known for the depicted content. The reference image can in particular be registered with respect to the microscope image when it is calculated from the microscope image by an image-to-image mapping, in particular by means of a learned model.

### Reference Image—Generation by Image Generator

The establishment or determination of the at least one reference image for the microscope image can also occur via a calculation of the reference image by an image generator. The image generator receives the microscope image and/or contextual information relating to the microscope image as input and is designed to calculate an output image (i.e. the reference image).

A machine-learned model acting as the image generator can have been trained, e.g., using training target images (annotations) with desired image properties or brightness-value properties. In the training, outputs of the model are intended to correspond to the training target images. The model thereby learns to generate images whose properties correspond to those of the training target images. A brightness-value property can be, e.g., a contrast of structures of interest. Training target images can exhibit a visibility, i.e. a high contrast, of structures of interest that has been categorized as high quality, while artefacts or undesirable image content (e.g. reflections) are suppressed or do not occur.

The image generator can have been conditioned using microscope images and/or contextual information, i.e. it is designed to receive a microscope image and/or contextual information and to use it to calculate the output image (=reference image). For example, a machine-learned language model (LLM, large language model) can be used to describe the microscope image. This description constitutes contextual information, which is input into the image generator. In this case, the image generator is designed as a text-to-image model. The LLM can be used, for example, to determine one or more pieces of contextual information—described in more detail later on—in the microscope image, e.g. an imaging mode and a sample type. Instead of an LLM, it is also possible to use a machine-learned classification model or encoder, which identifies contextual information in the microscope image by classification. To this end, it is possible, e.g., for different imaging modes or different sample types to have been used in the model training, with respect to which the model calculates a classification. The text-to-image model generates an image (=reference image) that is consistent with the contextual information, i.e., for example, an image captured in the same imaging mode and showing the same sample types as the microscope image. The reference image is not registered or not necessarily registered with respect to the microscope image, however. Nevertheless, the reference image can be utilized to determine the brightness value transformation of the microscope image.

The image generator can include an encoder that calculates an embedding or a feature vector for an input microscope image, for example by means of an (auto)encoder, a ViT encoder or PCA (principal component analysis). The image generator further includes a decoder that calculates an output image (=reference image) from the embedding. Alternatively, it is possible to use an LLM instead of the encoder to generate an image description as input for the image generator, which in this case can be designed as a text-to-image model. The image generator can in particular be or include a generative model of a GAN and/or a diffusion model.

### Reference Image-Retrieval From Database

The establishment/determination of at least one reference image for the microscope image can include retrieving a reference image from an image database as a function of the microscope image and/or the contextual information.

The image database includes a plurality of images with desired image properties or brightness-value properties. At least one image that matches or comes as close as possible to the microscope image is selected from the database. As the image database contains only images with desirable image properties, the selected image is suitable for use as a reference image for the establishment of the brightness value transformation of the microscope image. It is not necessary for the image selected from the database to be registered with the microscope image.

The database query can be implemented as an image retrieval by an embedding model, in particular a machine-learned embedding model, which calculates an embedding of the microscope image into a low-dimensional embedding space (with fewer dimensions than the microscope image). An embedding in the same embedding space is likewise stored for each image in the database. At least the image in the database whose embedding is the smallest distance away from the microscope image embedding is selected for a microscope image. The distance is measured in the embedding space. Thus, at least one image is selected that resembles the microscope image. In a variant of this embodiment, it is not the images themselves that are embedded, but rather contextual information relating to the same. As described above, the contextual information relating to an image can, for example, be generated from the image in question by an LLM or classification model. The database can subsequently be expanded without it being necessary to retrain the embedding model or other model.

For the sake of clarity, different embodiments are described with a single reference image. It is more generally possible to use one or more reference images. For example, brightness-value target data can be extracted from each reference image as described and then averaged.

### Contextual Information

The contextual information relating to the microscope image can specify in particular one or more of the following: a microscopy technique or a contrast type used in the capture of the microscope image; a sample type of a sample depicted in the microscope image, a sample condition, or a sample treatment.

Different microscopy techniques include, e.g., light microscopy, electron microscopy, X-ray microscopy, scanning probe microscopy, ion microscopy or ultrasound microscopy. Different contrast types can include, for example, brightfield, fluorescence or phase contrast (where appropriate, subdivided into different phase-contrast techniques such as Zernike phase contrast, DIC or Hoffman modulation contrast). A sample type can specify the type of sample analyzed and, e.g., distinguish between different types of rock, cell types in the case of biological cells, or electronic components under examination. A sample treatment can specify, e.g., employed dyes and/or other preparation steps. A sample condition can indicate, among other things, an age, a bleaching condition, or a health of biological cells, or a cell state (for example, mitosis, apoptosis).

Contextual information can alternatively or additionally specify a type and optionally a location of artefacts (e.g. hammerscale). It is also possible to specify as contextual information a type of experiment in the framework of which the microscope image was captured, or a type of biological application. In general, contextual information can define which aspects are important for the display of the image data.

Contextual information can also specify a position of important image regions that are to be displayed, e.g., with a high dynamic range. The image regions can be determined, for example, using a segmentation model that calculates, for each image pixel, whether the image pixel in question belongs to a specific object type. In principle, contextual information can also include the microscope image itself, or image data derived from the same, e.g. a lower-resolution variant of the image. User information, such as a user ID or a history, can also additionally be used as contextual information.

Contextual information can generally be provided in various forms, in particular in the form of text, numerical values, image data and/or a feature vector that describes the image content abstractly and can include all the aforementioned types of content, e.g. a sample type and a measurement technique.

### Determining the Contextual Information

Contextual information relating to a microscope image can be determined, for example, through an image analysis of the microscope image and/or by retrieving metadata of the microscope image.

Metadata is textual information or numerical values that are stored together with a microscope image. The metadata can specify, e.g., a microscope configuration or microscope settings at the capture of the microscope image and/or dyes used or other sample properties.

An image analysis can in particular be performed by a machine-learned model or, alternatively, by classic image processing algorithms. Learned models can be based on deep learning and use, e.g., CNNs or transformer-based networks. A learned model can in particular be designed to extract a feature vector that describes the microscope image abstractly in the form of a compressed representation.

Alternatively or additionally, a microscope user can be prompted to input contextual information manually, in particular via a language model which, as a function of available contextual information, asks for any missing contextual information. If, for example, the imaging mode of the microscope image could be determined with sufficient certainty via image analysis but not the sample type, then the language model can ask the user to input the sample type.

A user input can in particular be in the form of free text, for example in the form of an experiment description. An LLM can optionally use this description to extract a feature vector that contains contextual information. Different predefined setups can also be offered to a user for selection, e.g. a choice between a long-term experiment and an experiment with a high temporal resolution, and/or a selection of an employed dye from a list of dyes. The selection of the user is used as contextual information.

Contextual information can also be extracted from other image data than the microscope image. For example, in addition to the microscope image, at least one further image can be captured for the same sample, in particular an overview image or an image captured with different microscope settings or configurations. Such a further image can also provide further contextual information relating to the microscope image. For example, the sample type or other sample properties can be determined from an overview image.

Contextual information can generally be determined with machine learning models of different designs, e.g. models for classification, segmentation, detection, regression or anomaly detection/one-class classification. Such models can be designed to process image data, although in particular models for classification, regression or anomaly detection can also be configured to process other data.

### Brightness Value Transformation

The brightness value transformation can be a mathematical mapping of brightness values to new brightness values. Each (original) brightness value is thus assigned a new brightness value, which can generally be the same as or different from the original brightness value. The mapping can be a monotonic function. This means that the brighter a pixel in the microscope image is, the brighter the pixel is after the transformation, although it is also possible for a plurality of different brightness values to be mapped to the same new brightness value. The function can be applied to all pixels of the microscope image, so that the same rules are used to map each pixel of the microscope image to a new brightness value as a function its brightness value.

The brightness value transformation can be implemented, e.g., based on a power function (gamma correction) or by some other, in particular monotonic, function.

A mathematical function or a transformation model for the brightness value transformation can have, for example, the following parameters, the values of which are to be determined:
Two values which specify a lower and upper percentile of brightness values, whereby there occurs a min/max normalization of brightness values, i.e. a shifting of the black point and the white point; and/or
A minimum (brightness value below which all brightness values are set to black), a maximum (brightness value above which all brightness values are set to white) and a gamma value/gamma correction (wherein brightness values are adjusted by a power function and the gamma value specifies the power; depending on the gamma value, pixels are rendered brighter or darker and selectively enhanced at dark or light brightness values); and/or
A fixed or variable number of reference points/control points that define a grey-level transformation: a function/display curve assigns a new brightness value to each brightness value, wherein reference points are set at certain brightness values, which are assigned new brightness values; for all other values, a continuous or smooth function is fitted through the reference points;
Parameters for a histogram equalization; in the case of CLAHE, parameters can include a clip limit and/or a tile size.

The parameter values for the brightness value transformation can be determined in particular analytically or iteratively, e.g. through gradient descent methods and error backpropagation. The parameter values can also be established by a direct estimate, e.g. using classic machine learning models and/or deep neural networks such as CNNs or transformer-based models. It is also possible to infer parameter values by regression or ordinal regression. Parameter values for the brightness value transformation can also be established by a model learned using reinforcement learning.

For all of the machine-learning models for determining the parameters, which have been mentioned here by way of example, a model training is also possible solely with high-quality images, such as those found, for example, in specialist articles or promotional material for microscopes.

Parameter values of the brightness value transformation can in particular be defined using contextual information and/or the microscope image or a brightness-value frequency distribution of the microscope image (without the actual image data of the microscope image). The image data or image content can also be encoded by a feature vector and used accordingly.

By means of the brightness value transformation, the contrast for at least one original brightness-value range (e.g. dark pixels) is enhanced, while the contrast for at least one other brightness-value range (e.g. light pixels) is reduced. It is possible to determine depending on the microscope image and/or the contextual information in which brightness-value ranges the brightness value transformation is to produce a contrast enhancement and in which brightness-value ranges a contrast reduction is to occur.

The brightness value transformation can also be implemented as a preselection/presetting of display parameters. Display parameters can be, e.g., a gamma value, a white point and a black point. A user can then optionally adjust these parameters, as described in more detail later.

The brightness value transformation does not consist in a comparison with a threshold as in some classic segmentation algorithms, but rather in a mapping to a range of values (which can comprise, e.g., at least 16 or 256 different values). For a selective contrast enhancement, the mapping has a slope that is greater than 1 in sections (when the mapping is between two scales that are equal in color depth, for example from an original 256 different pixel values to the transformed set of 256 different pixel values).

### Brightness Value Transformation With a Registered Reference Image

As an example, parameter values of the brightness value transformation are to be established using a reference image that is registered with the microscope image. This can be the case, e.g., when the reference image was derived from the microscope image using an image-to-image model, as described above. The parameter values to be determined can be, e.g., the gamma value, the black point and the white point. The parameter values are established by means of an optimization: a pixelwise difference is calculated between the microscope image following the application of the brightness value transformation (using provisional parameter values that are to be optimized) and the reference image. To determine the pixelwise difference, the difference is captured for corresponding image coordinates in both images, and the captured differences are summed for all pixels. The pixelwise difference can be captured by means of a pixelwise loss function with, e.g., an L1 norm (sum of the absolute differences between the pixel values), L2 norm (which uses the sum of the squares of the differences in pixel value) or SSIM (structural similarity index measure). The parameter values are optimized so as to minimize the difference vis-à-vis the reference image. The overall impression of the reference image is thus replicated without fine details (artefacts/hallucinations) of the reference image being reproduced, since the microscope image can only be modified in a few parameters of the brightness value transformation.

### Brightness Value Transformation With an Unregistered Reference Image

In some embodiments, a reference image is used that is not registered with the microscope image. This can be the case, for example, when the reference image was obtained from a database by an image retrieval system, or when the reference image was generated by a generative model based on a textual description of the image. The parameter values of the brightness value transformation are determined iteratively, analogously to the foregoing example. To this end, the microscope image following the brightness value transformation with provisional parameter values is compared with the reference image. However, as the images are not co-registered, it is not possible to carry out a pixelwise comparison. Instead, a ‘style loss’ can be used for optimization, i.e. a loss function compares style characteristics rather than the depicted structures. The parameter values are adjusted until the style loss is minimized. Alternatively or in addition to a style loss, a discriminator can be used as in a GAN. The discriminator decides whether the microscope image following the brightness value transformation with provisional parameter values lies in the same domain as the reference image. It can correspond to a CycleGAN discriminator in terms of how it operates. In principle, the discriminator can be trained on the image in real time or can be pre-trained. The parameter values of the brightness value transformation are adjusted so that the discriminator is ultimately unable to reliably detect a difference between the image type (domain) of the transformed image and the image type of the reference image. Alternatively or additionally, it is also possible to use a loss function based on an artefact detection model which indicates whether/where image artefacts (e.g. hammerscale) are present in the image. The parameter values of the brightness value transformation are again adjusted so that the loss is minimized. The brightness value transformation thus ensures that artefacts contained in the microscope image are suppressed, i.e. the contrast of these structures is reduced or the image information of the artefacts is partially or completely removed by changing the black point/white point. For example, a hammerscale artefact can be suppressed by setting dark pixels to black by raising the black point. The described approach thus makes it possible to determine suitable parameter values automatically in order to bring about a suppression or masking of this unwanted image content in the event of the presence of a hammerscale artefact (which is also detected automatically). The brightness value transformation simultaneously ensures that no new image content is ‘hallucinated’ into the image.

### Image Display During Use of the Microscope

In various conventional approaches for improving a display quality that use machine learning models, both the original microscope image and the processed image are displayed. This comparison allows a user to assess whether the image processing has been executed correctly and in particular whether any serious artefacts have been generated.

In contrast, the brightness value transformation is suitable for an immediate enhancement of captured microscope images and their subsequent display. It is not necessary to provide a user with a comparison with the original image, as new, erroneous image content cannot be added by the brightness value transformation.

In different variants of the invention, the microscope image is captured with a microscope, wherein the microscope image is only displayed following the application of the brightness value transformation. This approach is also possible with live images, i.e. when a camera continuously captures images, which are displayed in the form of a video on a screen. The microscope image can in particular be displayed on a screen as a real-time image immediately following capture and the execution of the brightness value transformation.

For display on the screen, it can also be automatically determined which display color the image or a respective channel of the image should have. The display color is derived from the contextual information. For example, respective display colors can be stored for different dyes, fluorescence wavelengths and/or sample types. The values calculated by the brightness value transformation thus relate to a brightness for the selected display color. For example, stored information can specify that a blue coloring should be selected for an image with a DAPI dye.

In addition to the microscope image following the application of the brightness value transformation, it is also possible for the associated histogram of brightness values and/or the histogram of the original image to be displayed with visualized transformation parameters (e.g. display curve). Individual transformation parameters can also be displayed.

It is also possible to calculate and display a confidence or confidence map. The confidence (map) indicates the reliability or certainty of the optimized image. If confidence is too low, either no image at all, the original microscope image, or a min/max-normalized or percentile-normalized image can be displayed.

Confidence can be determined, e.g., based on the confidence probability values of the model prediction in cases where parameters were predicted directly, or based on differences between the prior image and the optimized image, and/or by an evaluation model that receives the optimized microscope image as input and has been trained to determine a confidence.

In variations of the variants of the invention described in connection with an image display, it can also be provided that, instead of or in addition to the display of the microscope image optimized by the brightness value transformation, the microscope image optimized by the brightness value transformation is transmitted to a subsequent image processing program. The subsequent image processing program can be designed, e.g., to segment or count certain objects. In this case, the accuracy of the image processing program can be increased when the visibility/contrast of the objects has been increased and the visibility of background structures has been reduced by the brightness value transformation.

### Feedback on a Modification of the Contextual Information or the Brightness Value Transformation

A user is optionally also shown the established contextual information used to determine the brightness value transformation together with the microscope image to which the brightness value transformation was applied. The user can be offered an input option to modify the contextual information used. This input option can be implemented, for example, via a dialog box, a selection from a list or a free-text input, optionally via voice input and/or by means of an LLM. For instance, a detected sample type can be indicated as contextual information, and a user can select or input a different sample type. This can be useful in particular when an analyzed sample contains different cell types and only one has been automatically detected. In the event of a modification of the contextual information, the brightness value transformation is recalculated (with the modified contextual information) and applied to the microscope image. The updating of the microscope image optimized by the brightness value transformation occurs essentially in real time.

More generally, a user can also provide, in addition to or instead of a correction of contextual information, further information or contextual information as feedback for a microscope image that has been optimized by a brightness value transformation. As described above, this feedback can be provided, e.g., via a dialog box or communication with an LLM, wherein the LLM evaluates user inputs. The user can, e.g., indicate that a brightness or a contrast of certain objects is too high/low or that certain objects should stand out more clearly against the background. Based on this feedback, the parameter values of the brightness value transformation are adjusted accordingly, for example in such a manner that a contrast of the objects specified by the user and a difference in brightness between the objects and the background are increased.

A list of possible feedback options can be provided from which a user can make a selection. The list can include options like, e.g.: ‘Overall image too bright’; ‘Sample areas too bright’, ‘Overall image too low in contrast’, ‘Sample areas too low in contrast’, etc.

A possible free-text input, which is analyzed by an LLM, might read, e.g.: “Hammerscale artefacts are still visible-please adjust the settings so that these are no longer visible”. If a user indicates that artefacts are too distracting, the parameter values of the brightness value transformation are adjusted to reduce the visibility of the artefacts (in particular by reducing a contrast for a brightness value range mainly occupied by the artefacts and/or so that the brightness value range mainly occupied by the artefacts is brought closer to the background). To this end, for example, a detection/segmentation can be carried out for an artefact type specified by the user (e.g., hammerscale artefact); a contrast of the brightness values mainly occurring in this determined image region should be reduced; the display curve is adjusted accordingly so that there is a flatter slope for this brightness-value range, i.e. the brightness-value range is mapped to a new, smaller brightness-value range.

Feedback of a user can also be provided by selecting (e.g. clicking on) a certain object in the microscope image that has been optimized by brightness value transformation. The user can select an object and specify how its visibility should be altered, in particular whether a visibility should be enhanced or suppressed. In a DAPI fluorescence image in which surrounding cell structures are visible in addition to cell nuclei, a user can, for example, click on the surrounding cell structures and specify that they should be suppressed to a greater extent. The image regions that show the selected object type (e.g. cell structures outside cell nuclei) can be determined through image analysis (e.g. segmentation). The parameter values of the brightness value transformation can in turn be adjusted so that a contrast is reduced for a brightness value range found more frequently in image areas of the cell structures than in image areas of the cell nuclei. The selection of a certain object can also occur via eye tracking, wherein camera images of the eyes of the user are used to ascertain which object in the displayed microscope image the user is looking at. This enables an interactive brightness value transformation and display of the microscope image.

User feedback can also relate directly to parameters of the brightness value transformation, whereupon the parameter values are adjusted accordingly. As an aid, it is possible to display the display curve that graphically illustrates the function through which brightness values of the original microscope image are mapped to new brightness values.

Feedback or contextual information can also be provided in the form of a manual adjustment of a calculated display curve by a user, in particular for a sample that has just been placed on the sample stage, or in the form of a display curve that is initially set for a microscope image by a user entirely manually. The image modification resulting from this display curve is automatically replicated in subsequent experiments. The same display curve is not used constantly here, as the resulting image modification depends significantly on the histogram of the microscope image in question. A new optimization of the display curve/brightness value transformation is carried out for each new microscope image, while the target properties remain constant. If, for example, a user has maximized the contrast for cell nuclei and reduced the contrast for other image content, a corresponding brightness value transformation is determined for subsequent microscope images that also produces this effect.

### Machine-Learned Models

The machine-learned models described in the present application can have been learned using training data and can include neural networks, in particular deep neural networks. Models can be trained by means of, e.g., supervised learning, unsupervised learning or semi-supervised learning. Reinforcement learning is also possible.

In different training variants, an objective function is optimized, e.g. a loss function is minimized or a reward function is maximized. Some embodiments are described here based on a loss function for the purposes of illustration, but it is understood that these embodiments can also be varied by optimizing some other objective function, e.g. a reward function. The iterative adjustment of model parameters can be carried out using an optimizer, e.g. gradient-based methods such as Adam or other gradient descent methods such as SGD (stochastic gradient descent). It is also possible to use backpropagation methods to adjust parameter values as a function of a current result of the objective function. Described embodiments based on gradient descent methods can be varied by using, alternatively or additionally, a simulated annealing.

A model can optionally include a plurality of individual models/submodels, which are trained separately or together. A model can also be designed as an ensemble model. A model can also be understood as a plurality of separately trained models whose results are combined by a majority voting.

It is also possible to employ a model distillation in which a teacher model is learned before a student model is learned with the soft output of the teacher model. The models described in the present application can thus be learned as student models in variant embodiments.

A model can include a CNN and can in particular be learned in a GAN architecture (GAN: generative adversarial networks), in particular as a StyleGAN or alias-free GAN. Diffusion models, autoencoders (e.g. variational autoencoders (VAEs) or transformer-based autoencoders) or transformer-based encoders, decoders or encoder-decoders are likewise possible.

In the training of a diffusion model (denoising diffusion model), noise of varying degrees is added to the training images, wherein the model learns a denoising, i.e. a separation of the image into a noise component and a signal component, whereby an image synthesis is learned. A feature space of the diffusion model can have a semantics. Diffusion models can include CNNs or use other processing layers instead of CNNs, in particular MLP mixers with multilayer perceptrons or attention-based blocks, for example transformers as in the case of ImageBART.

Described models can be modified so as to be designed for use with a RAG system (RAG: retrieval-augmented generation), so that the model can retrieve required information from an external database. A (multimodal) visual RAG is also possible in order to utilize image data from a database. It is thus easy to add data to the database after the training of the model so that the model can use said data without requiring retraining.

### General Features

A microscope image can be understood as an image that is captured by a microscope or that is calculated using measurement data of a microscope. The microscope image can in particular be formed by one or more raw images or further processed images of the microscope and can include 2D image data or a 3D image stack or volumetric data, or alternatively also time-series data in which 2D or 3D image data of the same object was captured at different points in time. A microscope image can be obtained via a microscope software interface or via a data storage medium. The microscope image can also be obtained manually by a user or automatically, e.g. as part of a workflow.

In principle, microscope images can depict any structure or object. In addition to the sample per se, e.g. biological structures, electronic elements or rock fragments, it is also possible for a sample vessel, a sample carrier, or a microscope component such as a sample stage or areas of the same to be depicted.

The microscope can be a light microscope with a system camera and, optionally, a separate overview camera. The overview camera or its objective is optionally non-telecentric. Other types of microscopes are also possible, for example electron microscopes, X-ray microscopes or atomic force microscopes. A microscopy system denotes a device that includes at least one computing device and one microscope.

The computing device can be designed in a decentralized manner, can be physically part of the microscope, or can be arranged separately in the vicinity of the microscope or at a location at any distance from the microscope. It can generally be formed by any combination of electronics and software and can in particular include a computer, a server, a cloud-based computing system or one or more microprocessors or graphics processors. The computing device can also be configured to control microscope components.

In the context of the present invention, an annotation is understood to be a target result ideally calculated by a model in training from an input associated with the annotation. The discrepancy between the model output and the annotation is used in the training to adjust the model parameters/weights. Depending on the model, an annotation can be an image, can include image data or a segmentation mask, or can be formed by other data, e.g. by numerical values or classifications by object type or size. In contrast to an annotation, contextual information refers to data that is input into the model as part of the input data for the calculation of the model output from said input.

Formulations such as “based on”, “using”, “depending on” or “as a function of” are not to be understood as exhaustive, so that further dependencies can exist. It is also possible to add intermediate steps: for example, the determination of the brightness value transformation as a function of contextual information can be implemented by using the contextual information directly for the definition of parameter values for the brightness value transformation, or by using the contextual information to obtain other data (e.g. a reference image or a reference histogram), and only this data, i.e. not the contextual information itself, is then used for the definition of parameter values for the brightness value transformation.

Descriptions in the singular are intended to cover the variants “exactly 1” as well as “at least one”. For example, the description of a use of a reference image covers both the possibility that exactly one reference image is used and the possibility that at least one reference image is used.

The described approach can be applied globally to the entire microscope image or locally to an image section. Brightness-value target data (in particular image statistics) can thus apply globally to the entire image, but also individually to local image regions. Similarly, the parameters of the transformation model/brightness value transformation can apply either globally to the entire image or to local image regions. Respective parameters for local image regions (e.g. divided into a grid) can either be considered separately from one another or be determined so as to be fluid/smooth across boundaries between neighboring regions. A display curve applied in a spatially variable manner in the image thus represents a kind of HDR (high dynamic range) with which a contrast is respectively increased locally. If the same transformation is applied to the entire microscope image, the risk of falsifications is virtually non-existent. Where the brightness value transformation includes a respective brightness value transformation for different image regions, the style characteristics of the image can be altered to a greater extent, wherein the display quality can also be further improved. For example, certain structures can be suppressed more effectively, while other structures can be displayed with a higher contrast. In the case of a respective brightness value transformation for different image regions, each of the brightness value transformations can be determined in the described manner. The boundaries between different image regions can be defined based on depicted content, e.g. using one or more segmentation masks in which a segmentation is performed according to the shown sample type/structure type or contained artefacts. It is thereby possible to render, for example, an image region of an artefact more similar to the background or to reduce its contrast, while an image region with the sample to be analyzed is displayed with an increased contrast.

For the sake of simplicity, embodiments are described with reference to a single image channel (grey-level image). However, an image can include any number of channels which correspond, for example, to different fluorescence channels, or to three colors such as RGB in the case of color images. In these cases, the described approach can be applied to each image channel. Brightness values can thus be understood as values of a certain image channel and do not necessarily have to specify the overall brightness resulting from all image channels. In the case of a multi-channel image, e.g. a color image, the brightness value transformation can alternatively be applied to the luminance or some other quantity that results from a combination of a plurality of channels or of all channels.

The characteristics of the invention that have been described as additional apparatus features also yield, when implemented as intended, variants of the method according to the invention. Conversely, the microscopy system or in particular the computing device and/or the computer program can be configured to execute the described method variants. Described training processes of machine-learned models define features of the ready-trained model, wherein different method variants are defined so that either the described training processes constitute method steps of a method according to the invention that are to be carried out or, alternatively, an accordingly trained model is used in the inference phase.

### BRIEF DESCRIPTION OF THE DRAWINGS

A better understanding of the invention and various other features and advantages of the present invention will become readily apparent by the following description in connection with the schematic drawings, which are shown by way of example only, and not limitation, wherein like reference numerals may refer to alike or substantially alike components:

FIG. 1 schematically shows processes of a conventional image correction;

FIG. 2 schematically shows processes of an example embodiment of the invention;

FIG. 3 schematically shows processes of a further example embodiment of the invention;

FIG. 4 schematically shows processes of a further example embodiment of the invention;

FIG. 5 schematically shows processes of a further example embodiment of the invention;

FIG. 6 schematically shows processes of a further example embodiment of the invention; and

FIG. 7 schematically shows an example embodiment of a microscopy system according to the invention.

### DETAILED DESCRIPTION OF EXAMPLE EMBODIMENTS

Different example embodiments are described in the following with reference to the figures.

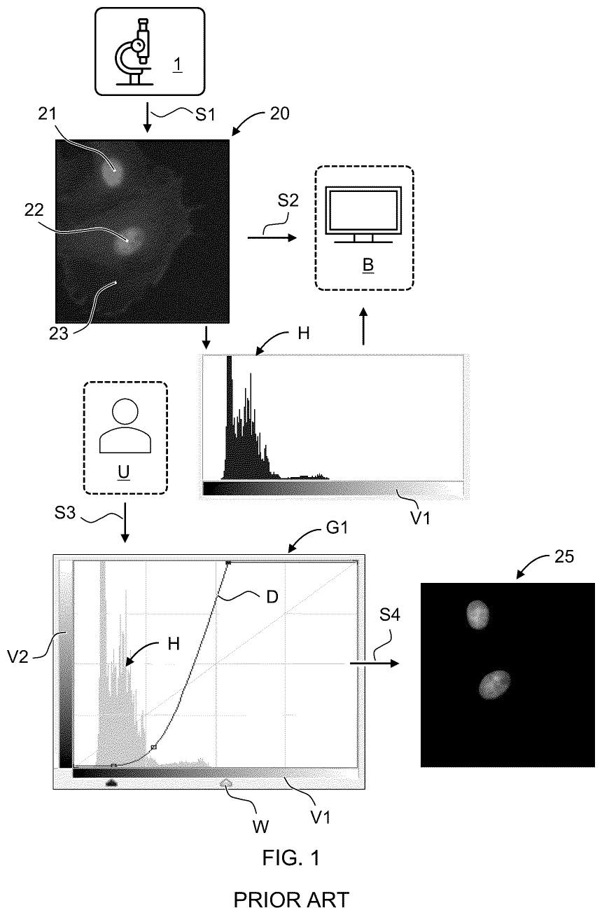

### FIG. 1: Display Correction According to the Prior Art

FIG. 1 schematically illustrates a conventional manual correction of the display of a microscope image.

In step S1, a microscope 1 captures a microscope image 20, which is then displayed on a screen B in step S2. The microscope image 20 here is a fluorescence image that shows two cell nuclei 21, 22 as well as cell structures 23 outside the cell nuclei resulting from crosstalk in the fluorescence channel.

A histogram H is also displayed on the screen B. The histogram H shows the frequency with which all possible brightness values (pixel values) V1 occur in the microscope image 20.

In step S3, a microscope user U sets a display curve D manually. The graph G1 shows a superimposition of the histogram H and the display curve D. The graph G1 shows all possible brightness values V1 (pixel values) of the original microscope image 20 on the horizontal axis. The brightness values can take a value, e.g., between 0 and 255 in the case of an 8-bit color depth.

The display curve D, or characteristic transformation curve, is a function that maps each brightness value V1 of the original microscope image 20 to a new brightness value V2. The brightness values V2 are shown on the vertical axis of the graph G1. If the display curve D is a straight line with a slope of 1 (as shown in the graph G1 for the sake of simplicity), the display curve D does not alter the brightness values of the microscope image 20.

The microscope user U can adjust the display curve D so that structures of interest are more prominent. In this example, an experienced user U lowers the display curve D for dark pixel values, so that dark pixels in the microscope image 20 become darker. As a result, the cell structures 23 turn black. The user U also sets the white level W appropriately. The white level W specifies a brightness value above which all brightness values of the original microscope image 20 become white. The user U sets the white level W approximately to the lightest brightness value in the microscope image 20.

In step S4, the display curve D is applied to the microscope image 20; i.e. the brightness values V1 are mapped to the brightness values V2 according to the display curve D, whereby a corrected microscope image 25 is calculated. The corrected microscope image 25 is displayed on the screen B.

The described approach requires experience and expertise. Moreover, even an expert is generally unable to replicate manual adjustments with precision for subsequent images.

In conventional automatic systems, the display curve is set solely as a function of simple image statistics, regardless of the structures displayed in the image and of the image type. This generally results in a moderate contrast enhancement for all structures shown, whereby the cell nuclei 21, 22 and other cell structures 23 would be slightly more prominent against the background, which, however, does not satisfy the application objectives of the present invention.

The invention, on the other hand, produces images of an improved quality, as explained in the following in more detail.

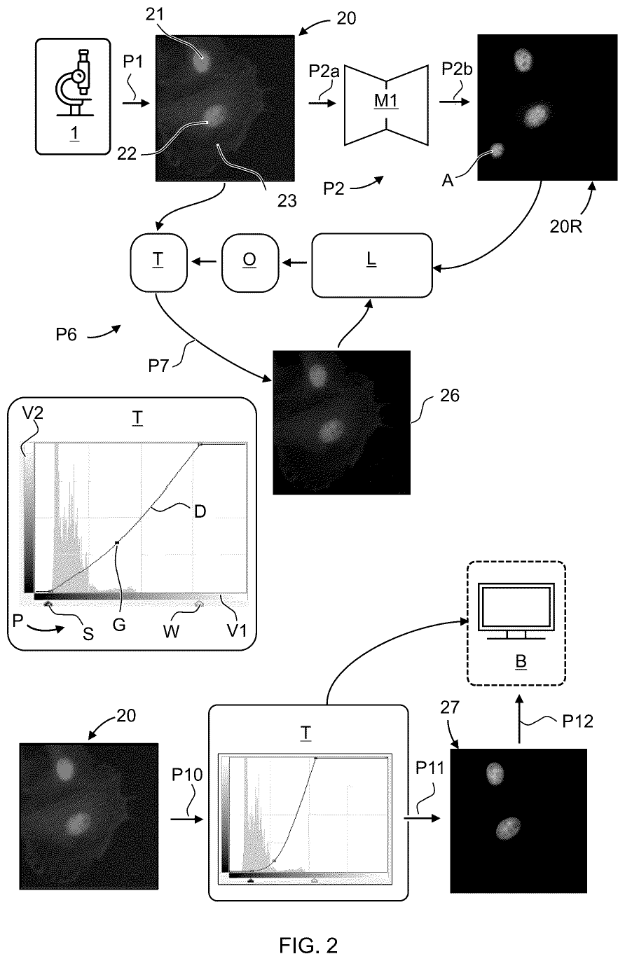

### FIG. 2: Brightness Value Transformation Using a Registered Reference Image

An example embodiment of a computer-implemented method according to the invention for improving an image quality/visual representation quality of microscope images is shown schematically in FIG. 2.

In process P1, a microscope image 20 is obtained, e.g. captured by a microscope 1. The microscope image 20 can be a raw image or an image that has been processed from raw data. In this example, it is a fluorescence image in which two cell nuclei 21, 22 have been rendered visible by a DAPI dye. However, other cell structures 23 outside the cell nuclei are also visible, which is undesirable.

In process P2, at least one reference image 20R is established for the microscope image 20. To this end, in process P2a, the microscope image 20 is input into an image-to-image model M1, which is trained to calculate a quality-enhanced output image from an input image, in process P2b. The output image is called the reference image 20R hereinafter. The image-to-image model M1 can have been trained, e.g., in a supervised manner, wherein input images in the training relate to the same domain (image type and sample type) as the microscope image. Predefined target images/annotations in the training are quality-enhanced vis-à-vis the input images in that, e.g., the visibility/contrast of structures of interest is increased, background structures are suppressed, or imaging artefacts are reduced.

In the illustrated example, the image-to-image model M1 calculates, from the microscope image 20, an output image (reference image 20R) in which the cell structures 23 are less visible while the cell nuclei 21, 22 of interest are displayed with a higher contrast. However, an artefact A—in this example a structure that was not present in the microscope image 20—has erroneously been added. The internal structure of the cell nuclei 21, 22 in the reference image 20R also differs from the actual structure in the microscope image 20.

In view of its improved image quality, the reference image 20R can nevertheless be used to optimize a display of the microscope image 20. To this end, a brightness value transformation T is determined in process P6. In the illustrated example, parameters of the brightness value transformation T are adjusted iteratively. The brightness value transformation T generates a mapping of the brightness values of the microscope image 20 to new brightness values. Each brightness value is assigned a new brightness value (which can be different from or the same as the original brightness value). The mapping is described by one or more parameters with values that are to be determined. For the purposes of illustration, the brightness value transformation T is depicted in the middle of the figure: in this example, it can be represented by a function (characteristic transformation curve/display curve D) which assigns a new brightness value V2 to each brightness value V1 of the microscope image 20. The brightness value transformation T or display curve D is defined by a plurality of adjustable parameters P, in this example by a black point S, a white point W and a gamma value G, or, alternatively, by at least one reference point (control point/support point) of the display curve D. As already explained, the black point S and the white point W specify threshold values, wherein all pixel values below the black point S are mapped to black (i.e. brightness value V2=0) and all pixel values above the white point W are mapped to white (i.e. brightness value V2=maximum). The gamma value G can be the power by which a brightness value V1 is mapped to a new brightness value, wherein the brightness values V1 can be converted to a scale from zero to one for this purpose. The display curve D has the value V2=0 for all values V1<S, then rises monotonically as of the point (V1=S, V2=0) and reaches the value V2=maximum (e.g. 255 with a 8-bit color depth) at V1=W. For values V1>W, V2 remains constant at V2=maximum. The slope of the display curve D is not linear and is defined by a provided function, e.g. a power function such as V1\hat{ }Gamma.

In principle, the black point S can also be mapped to a value V2>0 (i.e. V2=ps with ps>0) and/or the white point W can be mapped to a value V2<maximum (i.e. V2=pw with pw<maximum), whereby the resulting image utilizes only a limited brightness-value range ps to pw.

To adjust the parameters P (e.g. black point S, white point W and gamma value G) of the brightness value transformation T iteratively, the brightness value transformation T is first applied to the microscope image 20 with initial parameter values. The initial parameter values can be predetermined or predefined (e.g. black point S=0, white point W=maximum value and gamma value G=1 or a number other than 1), although the initial parameter values can also be set as a function of the microscope image 20 (e.g. initial value for black point S=smallest pixel value in the microscope image 20; initial value for white point W=largest pixel value in the microscope image 20).

In process P7, the brightness value transformation T (the first time with the initial values) is applied to the microscope image 20, whereby an image 26 with modified brightness values is obtained. A difference between the image 26 and the reference image 20R is captured by a loss function L. In this example, the loss function L calculates a difference consisting of the pixelwise difference between the image 26 and the reference image 20R. The result of the loss function L is used by an optimizer O to adjust the values of the parameters P of the brightness value transformation T. For example, a gradient descent method can be used to determine whether the current parameter values should respectively be increased or decreased in order to reduce the difference captured by the loss function L. The optimizer O can also specify or influence a step size by which a parameter value adjustment occurs in each iteration. A new image 26 is calculated with the modified parameter values in process P7 by applying the brightness value transformation T to the microscope image 20.

This iterative adjustment resembles the typical learning process in neural networks, although in this example the brightness value transformation T constitutes only a single layer, so that a backpropagation across multiple layers is not necessary for the parameter adjustment.

The iterative parameter adjustment ends when a stop criterion has been met, for example when a certain number of iterations has been reached and/or when a reduction in the difference captured by the loss function L over several iterations is less than a certain threshold value.

The thus determined values of the parameters P are now used for the brightness value transformation T. In process P10, the brightness value transformation T is applied to the microscope image 20, which yields a corrected image 27, in process P11. The corrected image 27 is adjusted vis-à-vis the microscope image 20 by a change in the brightness values. New structures or image content cannot be added by the brightness value transformation T. There is thus no risk—as there is with a learned image-to-image model M1—of a hallucination of artefacts A. As explained, a reference image 20R that contains artefacts A can still be used for determining suitable parameter values for the brightness value transformation T.

The corrected image 27 is displayed on a screen B in process P12. Optionally, the described processes are carried out immediately after image capture in process P1. The corrected image 27 can thus be displayed in real time, i.e. with a minimal time lag after data capture.

The brightness value transformation T can also be illustrated on the screen B, e.g. by a display curve D superimposed on the histogram of the brightness values of the microscope image 20. A microscope user can be offered the option of subsequently readjusting the determined parameter values of the brightness value transformation T.

The described approach differs from simple automatic systems for adjusting parameter values of a display curve D not only in the individual processes, but in the achieved result. A simple automatic system optimizes, for example, the contrast of all displayed structures. In contrast, the display curve D shown here reduces the contrast of darker structures or suppresses them completely. This eliminates the undesirable cell structures 23, which would tend to be displayed more prominently in the resulting image with simple automatic systems.

In a variant of the illustrated embodiment, more than one reference image 20R is used. For example, different amounts of noise can be added to the microscope image 20, or the microscope image 20 can be varied slightly in some other way, so that the image-to-image model M1 calculates different reference images 20R from the same microscope image 20. It is also possible to use a plurality of slightly different image-to-image models or individual models of a model ensemble to calculate a plurality of slightly different reference images 20R from the same microscope image 20. In the adjustment in process P6, the different reference images 20R can be used in turns for an iterative adjustment. Alternatively, an average of the reference images 20R is used in process P6.

In a further variant, a one-off definition/analytical determination of the parameter values occurs in process P6 instead of an iterative adjustment. This is in particular possible because the brightness value transformation T can be implemented by a simple surjective function.

In a further variant, the microscope image 20 is used instead of a modified image 26 in the (first) use of the loss function L. This corresponds to a brightness transformation T in which the display curve is a straight line with a slope of 1.

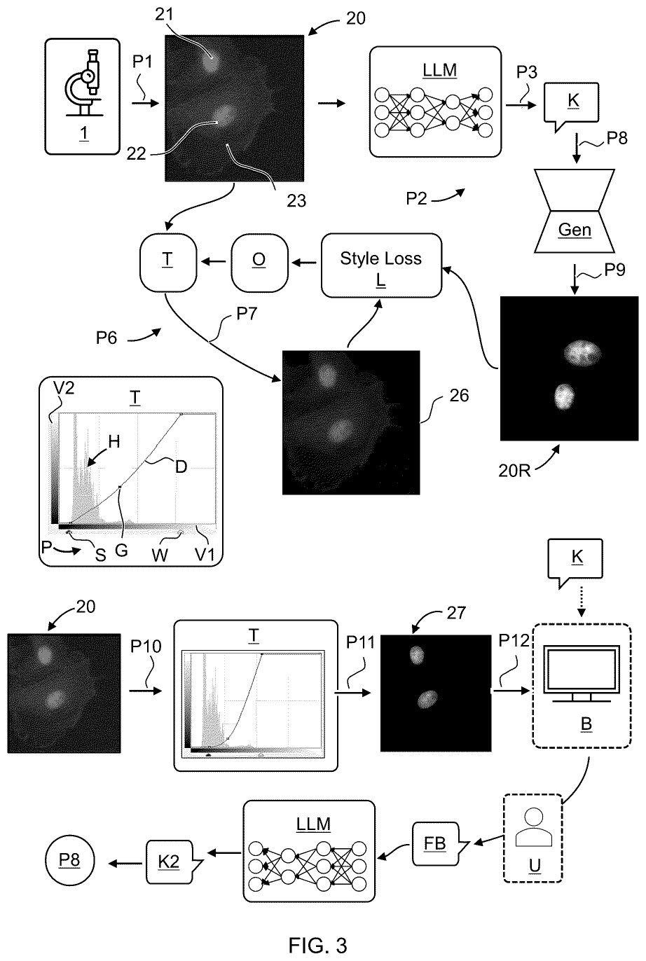

### FIG. 3: Brightness Value Transformation Using an Unregistered Reference Image

A further example embodiment of a method according to the invention is schematically shown in FIG. 3.

Elements shown in FIG. 3 with the same reference signs as in FIG. 2 can be designed as described with reference to FIG. 2 and are only briefly touched upon in the following.

In FIG. 3, a microscope image 20 is obtained, for which a reference image 20R is again determined. In this example, however, the reference image 20R is not registered with the microscope image 20. That is to say that pixels with the same image coordinates in the microscope image 20 and in the reference image 20R do not necessarily show the same structure.

The microscope image 20 is input into a large language model LLM, which, in process P3, generates a description of the microscope image 20, i.e. determines contextual information K relating to the microscope image 20. The description can be provided in text form and can relate, among other things, to an imaging modality (fluorescence image), imaging-relevant properties (DAPI dye) and/or depicted structures (two cell nuclei). This contextual information K is input into an image generator Gen (a text-to-image model in this example) in process P8, which generates a reference image 20R from the contextual information K in process P9. Processes P3/P4, P8, P9 together constitute a process P2 for establishing at least one reference image 20R for the microscope image 20.

The reference image 20R is consistent with the contextual information K and is thus a fluorescence image of two cell nuclei stained with DAPI in this example. However, these cell nuclei differ in size, shape and position from the cell nuclei 21, 22 in the microscope image 20. The reference image 20R can nevertheless be used to derive suitable values for the parameters P of the brightness value transformation T.

An image 26 obtained from the microscope image 20 by the brightness value transformation T with initial parameter values is input into a loss function L. The reference image 20R is also input into the loss function L. The loss function L does not calculate a pixelwise loss, as the two images are not co-registered. Instead, the loss function L calculates a style loss. A style loss captures differences in style characteristics. Positions of depicted structures, on the other hand, do not increase, or hardly increase, the difference captured by the style loss. A style loss can be calculated, e.g., by comparing the histograms of the two images. Alternatively, a style loss can be calculated by comparing the textures of the images: texture-based features such as contrast, homogeneity and entropy of both images are calculated, e.g. using grey-level co-occurrence matrices (GLCM). GLCMs indicate how often certain combinations of grey-level pairs occur in an image. The loss function can quantify the difference in texture-based features derived from the GLCMs. Alternatively or additionally, an edge detection can be performed, and the style loss can compare a number of edges or other edge properties in both images. The loss function L can thus capture a stylistic difference between the two unregistered images. Based on the result of the loss function L, an optimizer O adjusts values of the parameters P of the brightness value transformation T so that the loss function L is minimized. The values of the parameters P are defined by an iterative adjustment.

Next, in processes P10 and P11, a corrected image 27 can be calculated from the microscope image 20 by means of the brightness value transformation T and displayed on a screen B in process P12. Optionally, the contextual information K used in the framework of the brightness value transformation T is also displayed on the screen B. A user U is offered an input option to provide feedback (FB) on the corrected image 27 or the contextual information K used. In the illustrated example, the input option is implemented through communication with a language model LLM that calculates new contextual information K2 from the feedback FB provided by the user U. The new contextual information K2 is then used together with the original contextual information K in process P8, and the described processes are carried out again in order to generate a new corrected image 27 that takes the contextual information K2 into account.

A feedback FB of the user U can take the form of, for example, an indication that the displayed objects (in this case cell nuclei) are overexposed or that the contextual information specifies an incorrect object type. This feedback FB is used by the image generator Gen to generate a new reference image 20R with objects that are less bright or with a corrected object type.

Instead of, or in addition to, an LLM, an input option for feedback can also be implemented by allowing a user to select points, regions or objects in the corrected image 27 and to leave a corresponding comment regarding the display, e.g. ‘too bright’, ‘please improve contrast’ or ‘suppress structures’. The feedback FB here includes positional information together with the indication of how the image data should be modified. The positional information is optionally used to determine an object type or structure type, e.g. by determining which objects are located in which image regions via a segmentation or other techniques. Instead of the positional information, it is possible to use the determined object type/structure type in conjunction with the indication regarding the display as new contextual information K2 to define a new reference image.

In the event of a conflict between the new contextual information K2 and the original contextual information K, the original contextual information K (or parts thereof) can be replaced by the new contextual information K2. A user feedback FB can optionally be used directly as new contextual information K2. The described approach for using feedback FB can also be adopted as an additional feature in all other variant embodiments. Depending on the embodiment, the new contextual information K2 is not used by an image generator, but rather, e.g., as input into another learned model or for a database query, optionally following embedding in a feature space.

In a variant of the shown embodiment, the contextual information K is not input directly into the image generator Gen. Instead, an encoder, e.g. a transformer encoder, generates a mapping of the contextual information K into a feature space, and this mapping is input into the image generator Gen.

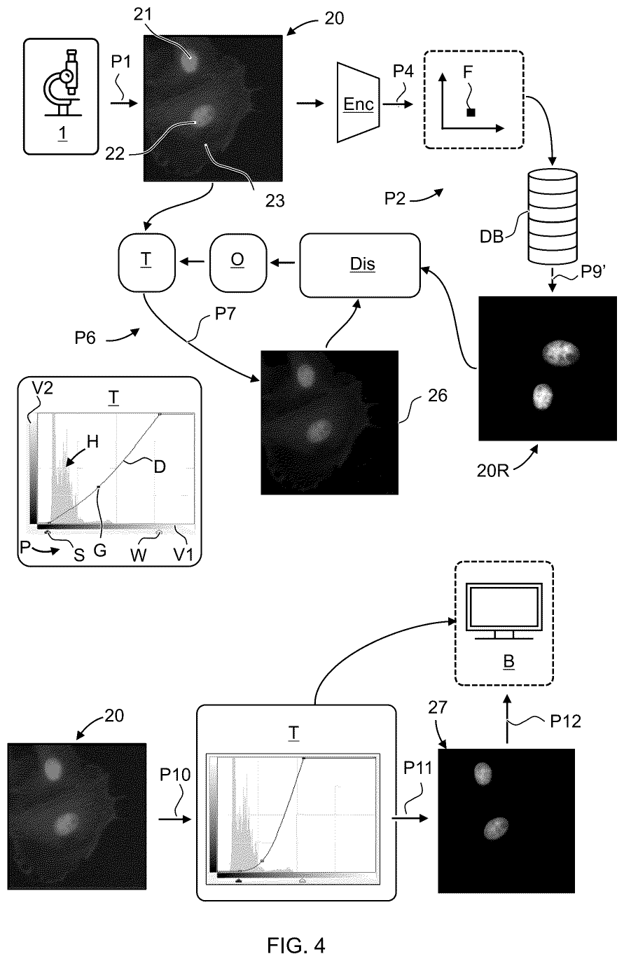

### FIG. 4: Retrieval of Reference Image From a Database Using a Microscope-Image Embedding

A variant of the preceding example embodiment is described with reference to FIG. 4.

In this case, an LLM does not generate a textual description of the microscope image 20. Instead, an encoder Enc, e.g. a transformer encoder, is used to calculate a feature vector F from the microscope image 20 in process P4. The feature vector F represents a compact, abstract numerical description of the microscope image 20. Optionally, the encoder Enc can be designed as a multimodal encoder capable of receiving text data in addition to image data. Text data can be, e.g., metadata of the microscope image 20 that contains contextual information.

Instead of the image generator used in the preceding illustrated example, an image database DB with stored images is used in FIG. 4. The image in the database DB that comes closest to the microscope image 20 is ideally selected as the reference image 20R, in process P9′. For this selection, an associated feature vector is stored in the database DB for each image in the image database DB, wherein the respective feature vectors can also have been calculated with the encoder Enc. At least the image in the image database DB whose feature vector is the smallest distance away from the feature vector F is selected as a reference image 20R.

A comparison between the reference image 20R and the microscope image 20 can occur via a style loss, as described with reference to the previous figure. In the illustrated example, however, a discriminator Dis is used instead. The discriminator Dis receives the reference image 20R and the microscope image 20 as inputs and assesses whether both images emanate from the same domain or are consistent in terms of imaging mode, imaging properties and/or sample type. Analogously to the use of a style loss in the previous figure, values of the parameters P of the brightness value transformation T are adjusted via an optimizer O as a function of a result of the discriminator Dis in order to minimize a difference captured by the discriminator Dis. The discriminator Dis can be a neural network and can in particular include a CNN and/or a transformer encoder. The discriminator can have been trained, for example, in a GAN architecture.

In principle, instead of the discriminator, it is possible to use a machine-learned anomaly detector, which receives the microscope image 20 as input. An anomaly detector can be selected from among a plurality of possible anomaly detectors according to the selected reference image 20R, so that the selected anomaly detector identifies discrepancies relating to the type of the reference image 20R.

It is possible to use combinations of the described illustrated examples. For example, the style loss described with reference to FIG. 3 can be replaced by a discriminator, or vice versa. The image generator Gen can be replaced by the image database BD so that a suitable image is selected from the image database BD as a function of contextual information K. In this case, the image database contains associated contextual information for each stored image.

Further variants of the embodiments of the illustrated examples result from a modification according to which, instead of determining a discrepancy between the microscope image 20 and the reference image 20R themselves, a difference between brightness-value data of the microscope image and brightness-value target data (i.e. brightness-value data of the reference image) is used, e.g. by a loss function L. Brightness-value data can specify, e.g., a homogeneity, entropy and/or spread of the frequency distribution of brightness values of the image in question. The parameter values of the brightness value transformation can be defined iteratively or analytically in order to reduce a discrepancy between the aforementioned properties.

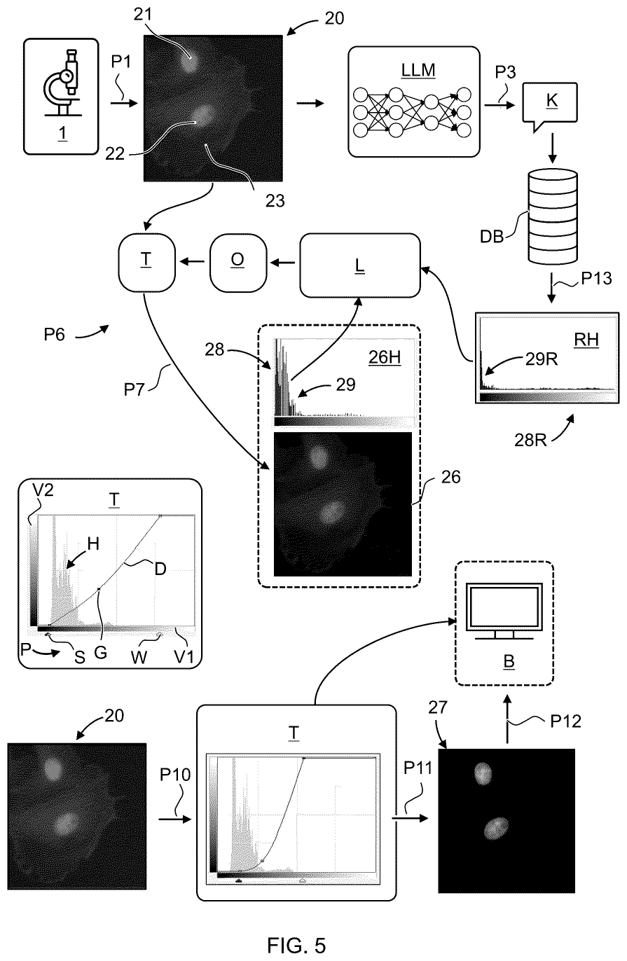

### FIG. 5: Brightness Value Transformation Using Reference Histograms

A further example embodiment of a method according to the invention is shown schematically in FIG. 5.

A language model LLM generates contextual information K from a microscope image 20 in process P3. High-quality images are stored in the database DB with respectively associated contextual information; alternatively, histograms of high-quality images are stored in the database DB with respectively associated contextual information. The image or histogram in the database DB whose contextual information matches or comes closest to the contextual information K of the microscope image 20 is selected, in process P13. The selected histogram is called the reference histogram RH. If an image is selected from the database DB, its histogram is used as the reference histogram RH.

The reference histogram RH for the contextual information K (here: fluorescence image of two cell nuclei) has an elevated frequency of black or almost black pixels, while other brightness values are approximately equally frequent and significantly less frequent than black pixels. Most of the image regions are thus black or almost black, while the cell nuclei largely use all brightness values from dark grey to white and thus have a high contrast.

In contrast, the histogram H of the original microscope image 20 (shown in FIG. 5 with the display curve D superimposed) exhibits a broad main peak at dark grey pixel values, which is attributable to the visible cell structures 23.

The microscope image 20 is ideally adjusted by the brightness value transformation T so that the histogram of the resulting image 26 is rendered more similar to the reference histogram RH. As described with reference to previous figures, an image 26 is calculated via the brightness value transformation T with initial or provisional parameter values. A histogram 26H of the image 26 should resemble the reference histogram RH as closely as possible. A difference between the histogram 26H and the reference histogram RH is used by a loss function L.

By means of the loss function L and an optimizer O, the values of the parameters P of the brightness value transformation T are modified so that a new image 26 is calculated, by means of the histogram 26H of which a loss is reduced, i.e. the loss function L is minimized iteratively.

In the illustrated example, the brightness value transformation T increased the frequency of black or almost black pixels, while average brightness values (which mainly correspond to the cell nuclei 21 and 22 in the microscope image) were spread over a wider brightness range. The histogram H of the original microscope image is thereby gradually brought closer and closer to the reference histogram RH.

Parameter values of the brightness value transformation T can also be established in this manner, which can be used to calculate a corrected image 27 as described with reference to previous figures.

In the approach described in the foregoing, the histogram 26H and the reference histogram RH can be entered into the loss function L as a whole, in the form of either images or numerical values (frequency distribution 29 of the brightness values of the microscope image 20 and target frequency distribution 29R of brightness values). Alternatively, one or more histogram properties of the histogram 26H (i.e. frequency-distribution properties of the microscope image 20) and histogram properties of the reference histogram RH (i.e. target frequency-distribution properties) can be input into the loss function L. These properties can specify, e.g., a spread, homogeneity, entropy and/or an average brightness value of the respective frequency distribution/histogram in question. Properties of the reference histogram RH that are entered into the loss function L are also referred to as brightness-value target data 28R. Analogously, properties of the histogram H that are input into the loss function L are referred to as brightness-value data 28. It is thus possible for the loss function L to capture only properties such as spread and average brightness value instead of an entire histogram, which still allows the microscope image to be brought closer to the reference image. The described process P13 can more generally consist in a determination of brightness-value target data 28R as a function of the contextual information K instead of the determination of a reference histogram RH from the database DB. The database DB can also contain other brightness-value target data instead of reference images or frequency distributions/histograms.

Which image property or which type of brightness-value data is to be optimized can be defined as a function of the contextual information K. It is likewise possible to define which parameters of the brightness value transformation are to be adjusted by the described approaches as a function of the contextual information K. If the contextual information indicates that artefacts or other undesirable image content is visible, it can be feasible to suppress this content when the adjustable parameters include a black point and/or a white point. In other cases, other adjustable parameters can be advantageous, e.g. a number of reference points/support points on the display curve that is defined as a function of the contextual information.

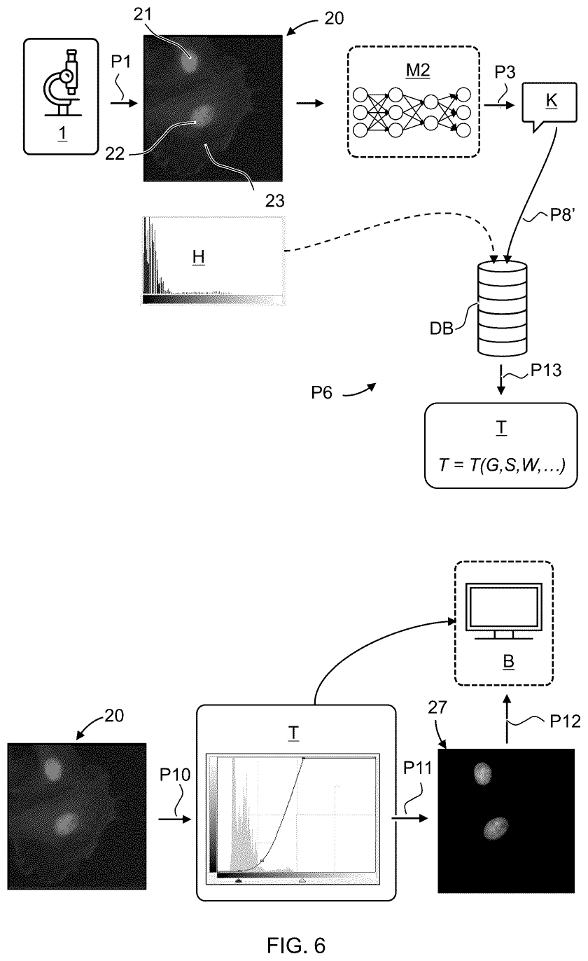

### FIG. 6: Database Containing Parameters for Brightness Value Transformation

A further example embodiment of a method according to the invention is shown schematically in FIG. 6.

In this example, a machine-learned model M2 analyzes the microscope image 20 in order to determine associated contextual information K in process P3. The model M2 can be, e.g., a classification model that is designed to classify different sample types and/or different contrast types.

The contextual information K is used in process P8′ for a database query. In this example, sets of parameter values are respectively stored in the database DB for the brightness value transformations T for different contextual information. In process P13, the set of parameter values is selected from the database DB whose associated contextual information best matches the contextual information K of the microscope image 20.

The database DB can contain stored content in tabular form. In order to establish a match or similarity between sets of contextual information, the contextual information can optionally be mapped into a feature space/embedding space by an embedding model, in particular a machine-learned transformer encoder. A distance between two embeddings in this space serves as a measure of the difference between associated sets of contextual information. The database DB can contain embeddings, so that these do not have to be recalculated for every database query.

It can optionally be provided that the histogram H or associated histogram properties are also used for the database query in process P8′. Properties of the brightness-value distribution potentially not covered by the contextual information K are thereby also used for the retrieval of suitable parameter values of the brightness value transformation T. For this embodiment, the database DB also includes histograms or associated histogram properties. The parameter values in the database are thus selected whose associated histograms/histogram properties and contextual information stored in the database DB are most similar to the contextual information K and to the histogram H of the microscope image 20.

In a variant of the shown embodiment, the database DB contains brightness-value target data instead of parameter values. The selection from the database is carried out as described above. Brightness-value data of the microscope image is subsequently brought closer to the selected brightness-value target data, whereby the parameter values of the brightness value transformation T are defined.

These approaches also enable a determination of a brightness value transformation T with suitable parameter values, by means of which it is possible to calculate and display a quality-enhanced image 27.

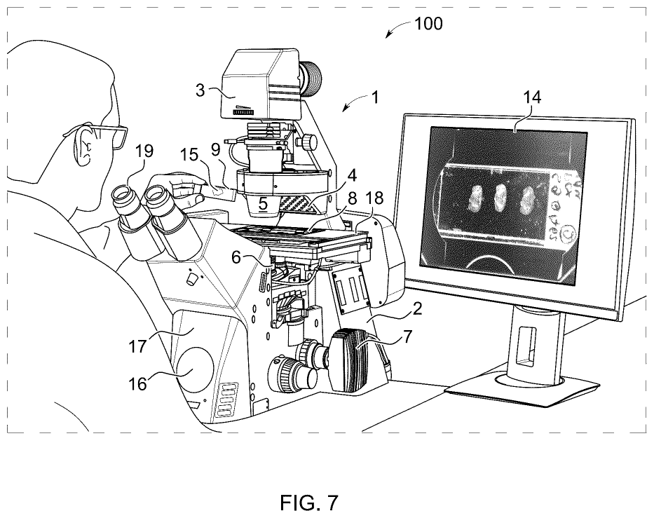

### FIG. 7: Microscope

FIG. 7 shows an example embodiment of a microscope system 100 according to the invention. The microscope system 100 includes a microscope 1 and a computing device 17, which can be part of the microscope 1 or separate from the microscope 1. The microscope 1 includes a stand 2 via which further microscope components are supported. The latter can in particular include: an illumination device 3; a condenser 5 for guiding illumination light to a sample area; an objective changer or revolver, on which an objective 6 is mounted in the illustrated example; a sample stage 18 with a supporting frame 8 for supporting a sample carrier 9; and a microscope camera 7. When the objective 6 is pivoted into the light path of the microscope, the microscope camera 7 receives detection light from a sample area in which a sample 15 can be located in order to capture a microscope image. In principle, a sample 15 can be or can include any object, fluid or structure. To acquire a microscope image that can serve as an overview image 14 of a sample environment, the microscope 1 can use an objective with a lower magnification and/or an optional additional overview camera (not illustrated), which views the sample area from a perpendicular or oblique angle. For the capture of an overview image, an illumination can be used that includes, e.g., a plurality of LEDs 4 whose illumination direction for a dark-field measurement is oriented obliquely to a detection axis. In addition to the microscope camera 7, a sample can also be observed through an eyepiece 19. The microscopy system 100 also includes a computer program 16, depicted only schematically, which is stored on a non-volatile data storage medium. The computer program 16 or the computing device 17 is configured to execute the method variants described in connection with the other figures. In the illustrated example, the microscope 1 is a light microscope, but in principle it can also be another type of microscope.

The variants described in relation to the different figures can be combined with one another. In all variants, processes can be added between the described or shown processes. Further data can also be added to the data used for a calculation. For example, further contextual information can be added to the described contextual information, which can be obtained, e.g., from image metadata, from experiment descriptions, or by querying a configuration or parameters of the microscopy system. The described example embodiments are purely illustrative and variants of the same are possible within the scope of the attached claims.

### LIST OF REFERENCE SIGNS

1 Microscope
2 Stand
3 Illumination device
4 LEDs
5 Condenser
6 Objective
7 Microscope/system camera
8 Supporting frame for supporting a sample carrier
9 Sample carrier
14 Microscope image/overview image
15 Sample
16 Computer program
17 Computing device
18 Sample stage
19 Eyepiece
20 Microscope image
20R Reference image
21, 22 Cell nuclei
23 Cell structure
25 Corrected microscope image
26 Image calculated by the brightness value transformation with current parameter values
26H Histogram for the image 26
27 Corrected image/microscope image
28 Brightness-value data for the microscope image 20
28R Brightness-value target data
29 Frequency distribution of brightness values of the microscope image 20
29R Target frequency distribution of brightness values, e.g. frequency distribution of brightness values of the reference image
100 Microscopy system
A Artefact caused by image processing
B Screen
D Display curve
DB Database/Image database
Dis Discriminator
Enc Encoder
F Feature vector of the microscope image
FB Feedback of a user
G Gamma value
G1 Graph
Gen Image generator
H Histogram
K Contextual information
K2 New contextual information calculated from feedback FB
L Loss function/Objective function
LLM Language model/Large language model
M1 Image-to-image model for calculating a reference image from the microscope image
M2 Model for calculating contextual information relating to the microscope image
O Optimizer
P Parameters of the brightness value transformation
P1-P13 Processes
RH Reference histogram
S Black point
S1-S4 Steps of a conventional process
T Brightness value transformation
U Microscope user
V1 Brightness values of the microscope image 20
V2 Brightness values of the corrected microscope image 25, 27
W White point

What is claimed is:

1. A computer-implemented method for improving an image quality of microscope images, including:
obtaining a microscope image;
determining contextual information relating to the microscope image, wherein the contextual information relates to at least imaging properties or depicted structures;
determining a brightness value transformation depending on at least the contextual information; and
applying the brightness value transformation to the microscope image.

2. The method according to claim 1,
wherein the determining of the brightness value transformation includes:
determining brightness-value target data depending on the contextual information; and
determining the brightness value transformation so that brightness-value data of the microscope image is brought closer to the brightness-value target data.

3. The method according to claim 2,
wherein the determining of brightness-value target data depending on the contextual information includes: determining at least one reference image depending on at least the contextual information and determining brightness-value target data based on the at least one reference image.

4. The method according to claim 1, which further includes:
determining at least one reference image for the microscope image; and
determining the brightness value transformation of the microscope image such that a difference between the microscope image and the reference image is reduced.

5. A computer-implemented method for improving an image quality of microscope images, including:
obtaining a microscope image;
determining at least one reference image for the microscope image;
determining a brightness value transformation of the microscope image which reduces a difference between the microscope image and the reference image; and
applying the brightness value transformation to the microscope image.

6. The method according to claim 5, which further includes:
determining brightness-value data for the at least one reference image as brightness-value target data; and
determining the brightness value transformation so that brightness-value data of the microscope image is brought closer to the brightness-value target data.

7. The method according to claim 5,
wherein the determining of the at least one reference image for the microscope image includes:
calculating the reference image from the microscope image using an image-to-image model that is trained to calculate a quality-enhanced output image as the reference image from an input microscope image.

8. The method according to claim 7,
wherein the reference image calculated by the image-to-image model is registered with the microscope image; and
wherein values of parameters of the brightness value transformation are defined by minimizing a pixelwise difference between the microscope image and the reference image.

9. The method according to claim 3,
wherein the determining of the at least one reference image for the microscope image includes:
calculating the reference image by an image generator, which receives the microscope image or contextual information relating to the microscope image as input and is configured to calculate an output image, wherein the image generator is trained using training target images with desired brightness-value properties.

10. The method according to claim 9,
wherein a machine-learned language model generates a textual description of the microscope image as contextual information; and
wherein the textual description generated by the machine-learned language model is input into the image generator, which is designed as a text-to-image model.

11. The method according to claim 3,
wherein the determining of the at least one reference image for the microscope image includes:
retrieving a reference image from a database as a function of at least one of the microscope image and the contextual information.

12. The method according to claim 2,
wherein the brightness-value target data specify a target frequency distribution of brightness values, and wherein the determining of the brightness value transformation is carried out so that a frequency distribution of brightness values of the microscope image is brought closer to the target frequency distribution;
or
wherein the brightness-value target data specify target frequency-distribution properties, and wherein the brightness value transformation is carried out so that frequency-distribution properties of the microscope image are brought closer to the target frequency-distribution properties.

13. The method according to claim 2,
wherein the brightness-value target data specify an image statistical target of brightness values, and
wherein the determining of the brightness value transformation is carried out so that an image statistic of the microscope image is brought closer to the image statistical target.

14. The method according to claim 2,
wherein brightness-value target data is stored in a database for different contextual information.

15. The method according to claim 1,
wherein the contextual information specifies one or more of the following: a microscopy technique or a contrast type used in capturing the microscope image, a sample type, a sample condition, or a sample treatment;
wherein the contextual information is determined through at least one of an image analysis of the microscope image and by retrieving metadata of the microscope image.

16. The method according to claim 1,
wherein the brightness value transformation is a mapping of brightness values to new brightness values, wherein the mapping is a monotonic function and is applied to all pixels of the microscope image.

17. The method according to claim 1, which further includes:
determining, depending on at least one of the microscope image and the contextual information, at least one brightness-value range in which the brightness value transformation is to produce a contrast enhancement, and at least one brightness value range in which the brightness value transformation is to produce a contrast reduction.

18. The method according to claim 1, which further includes:
capturing the microscope image with a microscope; and
displaying the microscope image only following the application of the brightness value transformation;
wherein the microscope image is displayed as a real-time image on a screen immediately following capture and the execution of the brightness value transformation.

19. The method according to claim 1, further comprising:
displaying the contextual information determined and used for the determining of the brightness value transformation to a user together with the microscope image to which the brightness value transformation has been applied,
providing an input option for the user to modify the contextual information used, in the event of a modification of the contextual information by the user: recalculating the brightness value transformation and applying the brightness value transformation after recalculation to the microscope image.

20. A microscopy system including:
a microscope for image acquisition; and
a computing device that is configured to execute the computer-implemented method according to claim 1.

21. A non-volatile computer-readable data storage medium including a computer program that includes commands that, when executed by a computer, cause the computer to execute the method according to claim 1.
